(19) United States
(12) Patent Application Publication
(10) Pub. No.: US 2006/0194142 A1
(43) Pub. Date: Aug. 31, 2006

(54) IMMERSION LITHOGRAPHY WITHOUT USING A TOPCOAT

(76) Inventor: Benjamin Szu-Min Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/906,582

(22) Filed: Feb. 25, 2005

(51) Int. Cl. G03C 1/76

(52) U.S. Cl. 430/270.1

(57) ABSTRACT

A novel immersion medium for immersion lithography is provided. The immersion medium is introduced to fill a gap in between a front surface of a projection lens of a stepper and a top surface of a photoresist layer coated on a substrate positioned on a wafer stage. The present invention is characterized in that the immersion medium has a pH value matching that of the photoresist layer in order to prevent effects caused by photo acid generator (PAG) leaching from the photoresist layer to the immersion medium during exposure.

### BACKGROUND OF INVENTION

1. Field of the Invention

The present invention relates generally to the field of semiconductor fabrication and, more particularly, to an improved immersion lithography and immersion medium thereof. According to the present invention, a topcoat typically used to prevent acid out diffusion of the photoresist can be omitted.

2. Description of the Prior Art

Photolithographic systems have been a mainstay of semiconductor device patterning for decades. In photolithographic systems, as known in the art, light is projected onto a photoresist for the purpose of patterning an electronic device on a semiconductor substrate or wafer.

The resolution (r₀) of a photolithographic system having a given lithographic constant k₁, is described by the equation
r₀=k₁λ/NA (1)

where λ is the operational wavelength, and numerical aperture (NA) is given by the equation
NA=n sin θ₀ (2)

Angle θ₀ is the angular semi-aperture of the system, and n is the index of the material filling the space between the system and the substrate to be patterned.

Conventional methods of resolution improvement have lead to three trends in the photolithographic technology: (1) reduction in wavelength λ from mercury g-line (436 nm) to the 193 nm excimer laser, and further to 157 nm and the still developing extreme-ultraviolet (EUV) wavelengths; (2) implementation of resolution enhancement techniques such as phase-shifting masks, and off-axis illumination have lead to a reduction in the lithographic constant k₁ from 0.6 to values approaching 0.4; and (3) increases in the numerical aperture (NA) via improvements in optical designs, manufacturing techniques, and metrology. Such improvements have lead to increases in NA from approximately 0.35 to greater than 0.7, with 0.8 expected in the next few years. However, as can be seen in Equation (2), for free-space optical systems (i.e., n=1), there is a theoretical limit bounding NA to values of one or less.

Immersion lithography provides another possibility for increasing the NA of an optical lithographic system. Immersion lithography is a technology in which lithographic exposure of a resist coated wafer is performed with immersion fluid such as purified water introduced between the projection lens of a stepper and the wafer. The light source of the leading-edge stepper currently used in production lines is the ArF 193 nm excimer laser, and the resolution is approximately 90 nm. 65 nm is said to be the limit even for a system for research and development. The idea behind immersion lithography is to use the same ArF light source and yet realize a semiconductor process technology that achieves a resolution higher than 65 nm.

In immersion lithography, the medium through which the exposure light passes is purified water, with a refractive index of about 1.44 and a pH value of 7.0, rather than air. Therefore, the NA can be increased by a factor of up to 1.44, and it will enable us to surpass the barrier of the 65 nm line width, which is considered the limit for ArF steppers. Theoretically, the technology is expected to be capable of extending micro processing down to the 45 nm line width. This will cover the range of steppers utilizing the F₂ laser, which is considered the next light source after ArF. In other words, this will accommodate fabrication of the next generation LSI without having to significantly change production facilities.

However, there are a few issues that need to be addressed in order for immersion lithography to materialize. One issue is how to deal with the purified water filling the space between the projection lens and the wafer. For instance, chemical substances such as photo acid generators (PAGs) leached from the photoresist to the water during exposure can adversely affect the image on the wafer. Such alteration in the properties of water is critical in this art. Some prior arts thus utilize a topcoat material coated on the photoresist in order to prevent interaction of the pure water and photoresist.

### SUMMARY OF INVENTION

It is therefore a primary objective of the present invention to provide an improved immersion lithography technology to solve the prior art problems.

In accordance with one preferred embodiment, from one aspect of the present invention, a novel immersion medium for immersion lithography is provided. The immersion medium is introduced to fill a gap in between a front surface of a projection lens of a stepper and a top surface of a photoresist layer coated on a substrate positioned on a wafer stage. The present invention is characterized in that the immersion medium has a pH value matching that of the photoresist layer in order to prevent effects caused by photo acid generator (PAG) leaching from the photoresist layer to the immersion medium during exposure.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic cross-sectional diagram illustrating the preferred embodiment of the present invention.

### DETAILED DESCRIPTION

The present invention pertains to an improved immersion lithography technology involving the use of “non-neutral” immersion mediums, which solves the aforesaid photo acid generator (PAG) leaching problem and thus effectively extends the limits of ArF Steppers. The term “non-neutral”, hereinafter, refers to a pH value that is not equal to 7.0.

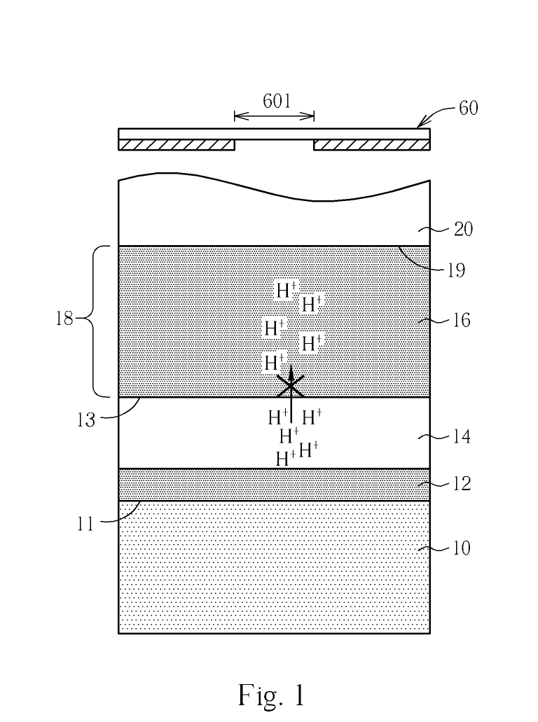

Please refer to FIG. 1. FIG. 1 is a schematic cross-sectional diagram illustrating the preferred embodiment of the present invention. As shown in FIG. 1, a silicon wafer or a semiconductor substrate 10 is positioned on a wafer stage (not shown). A photo mask 60 is disposed above the semiconductor substrate 10. The photo mask 60 comprises transparent area 601 that allows light to pass therethrough. The semiconductor substrate 10 has a top surface 11 on which a layer of commercially available anti-reflection coating 12 is disposed. A photoresist layer 14 is coated over the anti-reflection coating 12. In accordance with the preferred embodiment of this invention, the photoresist layer 14 is a positive photoresist layer, but not limited thereto. The photoresist layer 14 is prone to PAG leaching during exposure to light, which is ArF 193 nm excimer laser according to this embodiment. According to the prior art, such PAG leaching leads to declined pH values of the immersion medium such as water.

A projection lens 20 having a front surface 19 is juxtaposed in proximity to the photoresist layer 14. A gap 18 is defined in between the top surface 13 of the photoresist layer 14 and the front surface 19 of the projection lens 20 of a stepper. A non-neutral immersion medium 16 is introduced to fill the gap 18 between the projection lens 20 and the photoresist layer 14. In the case that the underlying photoresist layer 14 is prone to PAG leaching during exposure to light, the non-neutral immersion medium 16 is adjusted to match the pH value of the photoresist layer 14. The pH value of the photoresist layer 14 may be measured at its liquid state. The non-neutral immersion medium 16 may be aqueous solution including a buffer system such as hydrochloric acid-potassium chloride buffer solution in order to keep the pH value of the immersion medium 16 at a substantially constant value throughout the lithographic process.

It is worthy noted that a topcoat, which is typically coated on the top surface 13 for preventing PAG leaching, is deliberately omitted according to this invention. By doing this, the process steps are simplified and thus cost is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An immersion medium for immersion lithography, said immersion medium being introduced to fill a gap in between a front surface of a projection lens of a stepper and a top surface of a photoresist layer coated on a substrate positioned on a wafer stage, characterized in that:
said immersion medium has a pH value matching that of said photoresist layer in order to prevent effects caused by photo acid generator (PAG) leaching from said photoresist layer to said immersion medium during exposure.

2. The immersion medium according to claim 1 further characterized in that said immersion medium is aqueous solution including a buffer system to keep said pH value of said immersion medium at a substantially constant value throughout lithographic process.

3. The immersion medium according to claim 1 further characterized in that said photoresist layer is prone to PAG leaching during exposure to light.

4. The immersion medium according to claim 3 further characterized in that said light is ArF 193 nm excimer laser.

5. The immersion medium according to claim 1 further characterized in that said photoresist layer is positive photoresist.

6. An immersion medium for immersion lithography, said immersion medium being introduced to fill a gap in between a front surface of a projection lens of a stepper and a top surface of a photoresist layer coated on a substrate positioned on a wafer stage, characterized in that:
said immersion medium has a pH value matching that of said photoresist layer in order to prevent effects caused by photo acid generator (PAG) leaching from said photoresist layer to said immersion medium during exposure, and wherein there is no topcoat interposed between said immersion medium and said photoresist layer.

7. The immersion medium according to claim 6 further characterized in that said immersion medium is aqueous solution including a buffer system to keep said pH value of said immersion medium at a substantially constant value throughout lithographic process.

8. The immersion medium according to claim 6 further characterized in that said photoresist layer is prone to PAG leaching during exposure to light.

9. The immersion medium according to claim 8 further characterized in that said light is ArF 193 nm excimer laser.

10. The immersion medium according to claim 6 further characterized in that said photoresist layer is positive photoresist.
